(19) United States
(12) Patent Application Publication
(10) Pub. No.: US 2013/0107938 A9
(43) Pub. Date: May 2, 2013

(54) Method And Apparatus For Scalable Video Decoder Using An Enhancement Stream

(71) Applicants: Chad Fogg, Pullman, WA (US); Richard Webb, McKinney, TX (US); Andrew Segall, Camas, WA (US)

(72) Inventors: Chad Fogg, Pullman, WA (US); Richard Webb, McKinney, TX (US); Andrew Segall, Camas, WA (US)

(21) Appl. No.: 11/539,579

(22) Filed: Oct. 6, 2006

Related U.S. Application Data
(63) Continuation-in-part of application No. 10/446,347, filed on May 28, 2003, now Pat. No. 7,386,049.
(60) Provisional application No. 60/724,997, filed on Oct. 7, 2005.

(51) Int. Cl. H04B 1/66; H04N 11/04

(52) U.S. Cl. 375/240.1; 375/240.24

(57) ABSTRACT

A method and apparatus is provided for decoding an encoded baseline video stream and an enhancement stream. The baseline video stream is decoded, upscaled and enhanced by applying adaptive filters specified by the enhancement stream. Baseline upscaled images are then coded to motion compensate enhanced high resolution images using previously decoded enhanced images, thus recycling these enhanced images. The enhancement stream provides the best predictor method for the decoder to combine blocks from previous enhanced images and upscaled images to produce a motion compensated enhanced image. Likewise, forward and backward motion compensated images are blended according to feature classification and filter extraction methods provided by the enhancement stream to produce a bidirectionally predicted frame. Lastly, the decoder applies residual data from the enhancement stream to produce a completed enhanced image.

### RELATED DOCUMENTS

The subject matter herein relates to U.S. Provisional Patent Application 60/724,997, filed Oct. 7, 2005, which is incorporated by reference herein and to which priority is claimed, and also relates to pending U.S. patent application Ser. No. 10/446,347 titled “Predictive Interpolation of a Video Signal”, Ser. No. 10/447,213 titled “Video Interpolation Coding”, and Ser. No. 10/447,296 titled “Maintaining a Plurality of Codebooks Related to a Video Signal”, each of said applications being incorporated by reference here.

### BACKGROUND OF THE INVENTION

1. Field of the Invention

The present invention relates to the field of digital video processing, and more particularly to methods and apparatuses for decoding and enhancing sampled video streams.

2. Description of the Prior Art

As video sources march towards ever high resolutions for improved display quality, existing distribution and playback technologies do not always keep pace. Transmitting and recording higher quality video using the existing transmission and writable media infrastructure requires video processing techniques to upgrade system deficiencies and to meet the demands of higher quality video presentation.

Methods such as interlacing and scalable decoding are used to compress digital video sources for transmission and/or distribution on writeable media and to decompress the resultant video stream (defined herein as an array of pixels comprising a set of image data) to provide a higher quality facsimile of the original source video stream. De-interlacing takes lower resolution interlaced video sequences and converts them to higher resolution progressive image sequences. Scalable coding takes a lower-quality video sequence and manipulates the video data in order to create a higher quality sequence.

Video coding methods today that are applied to proportionally higher quality video streams for transmission on existing channels require a commensurate increase in channel capacity. To support both legacy and new resolutions, systems today transmit two distinct video streams for presentation so that both a low resolution and high resolution video presentation system can be supported. This approach requires separate channels for each of the low resolution and high resolution streams.

Removable media for use in playback systems today that support low resolution video lack the storage capacity to simultaneously carry a low resolution version of a typical feature-length video as well as an encoded high resolution version of the video. Further, encoding media with optional high resolution presentation techniques often precludes use of that media with systems that support low resolution-only playback.

Today, when presented with a standard resolution video stream, high-resolution display systems up-sample the stream to match the display resolution. Up sampling produces a visually inferior picture to that of a native high resolution video stream. For example, images from such up-sampling are often slightly blurry or soft. To compensate, these systems apply global filters over an entire image to sharpen the otherwise soft picture. However, such techniques introduce perceptible artifacts as they attempt to emulate a higher resolution video stream without adequate information about original high resolution stream.

Today's digital video standards rely upon block based compression which is lossy, introducing visually perceptible block artifacts upon presentation of the decoded image stream. Artifacts may be reduced by applying de-blocking filters to the decoded image stream; however, this method introduces additional inaccuracies from a true reconstruction of the original video stream. Another method reduces the resolution of the video stream before encoding resulting in a loss of image fidelity proportional to the image reduction. Another method uses increasingly smaller block sizes to further reduce inaccuracies introduced by compression. This method reduces the compression ratio and increases the size of the transmitted data stream. Still another method encodes the highest possible resolution video stream for transmission with similar trade-offs as the previous method.

In an effort to reconstruct an output image that is more true to the original source (before encoding), classic decoders may combine two images, a temporally predicted image, and an up-sampled image, on a block by block basis. This method of combining images requires an explicit signal for every change in block processing of every image, increasing stream complexity and size. More advanced techniques such as CABAC require side information signaling performing substantially the same function on a per block and per image basis.

### SUMMARY OF THE INVENTION

Accordingly, the present invention is directed to systems and methods for obtaining from an encoded baseline low resolution video stream a low resolution and high resolution video stream. The encoded baseline low resolution video stream is employed together with an enhancement video stream at a video decoder.

Baseline video stream is defined herein as a bit stream of low resolution video images. Enhancement stream is defined herein as a bit stream that directs a decoder to produce improvements in fidelity to a decoded baseline video stream. The terms low resolution and high resolution are applied herein to distinguish the relative resolutions between two images. There is no specific numerical range implied by the use of these terms for these two video streams and do not imply specific quantitative measures. A video stream is defined herein as an array of pixels comprising a set of image data.

It is understood that the terms forward and backward used herein when referencing motion compensation, predictors, and reference images are referring to two distinct images that may not be temporally after or before the current image. For example, forward motion vector and backward motion vector refer to only to motion vectors derived from two distinct reference images.

Various embodiments of the present invention highlight a number of features, including:
An efficient method of coding high resolution motion vectors using a low resolution base layer;
An adaptive filter method for locally enhancing blocks of an up-sampled, low resolution video stream to more accurately represent its high resolution equivalent;
A method for decoding and extracting motion vectors of an up-sampled baseline video stream and applying the vectors to motion compensate an enhanced high resolution video stream;
A method of residual enhancement applied to images on a block by block basis which can use basis vectors in the enhancement bitstream which have be optimized based on the properties of the uncompressed residual signal;
A method of reusing blocks of enhanced pixels from previously enhanced images for reconstructing motion compensated images;
An apparatus for decoding a bit stream containing an encoded low resolution video stream and an enhancement stream to produce a high resolution video stream;
A coding method for improving accuracy of motion estimation without significant increase in the data stream;
A method of adaptively combining a temporally predicted image and a spatially predicted image to produce an improved output image advantageously eliminating the need for block by block signaling;
A method for changing the filter in which images are combined on a block by block basis by reacting the image applying classification and filtering to change modes in a predetermined way is provided;
A low resolution base layer is transmitted on one channel while an enhancement channel is simulcast separately to support a higher resolution; and
The provision of some or all of the aforementioned aspects together in a single system and single method capable of providing both a low resolution and high resolution video stream from an encoded baseline low resolution video stream together with an enhancement video stream processed at a video decoder.

According to one aspect of the present invention, a method is provided for decoding and enhancing a video image stream from a bitstream containing at least sampled baseline image data and image enhancement data, comprising: separating the bitstream into blocks of sampled baseline image data and image enhancement data; adaptively upsampling the sampled baseline image data on a block-by-block basis to produce upsampled baseline image data, the adaptive upsampling controlled at least in part by a portion of the image enhancement data for each block; enhancing the upsampled baseline image data by applying to the upsampled baseline image data residual corrections, the residual corrections compressed using a predetermined transform, to thereby obtain enhanced image data; and outputting the enhanced image data.

According to a further aspect of the present invention, a method is provided for decoding and enhancing a video image stream from a bitstream containing at least sampled baseline image data and image enhancement data, comprising: separating the bitstream into blocks of sampled baseline image data and image enhancement data; adaptively upsampling the sampled baseline image data on a block-by-block basis to produce upsampled baseline image data, the adaptive upsampling controlled at least in part by a portion of the image enhancement data for each block; determining motion vector data from a portion of the image enhancement data; enhancing the upsampled baseline image data by applying to the upsampled baseline image data residual corrections, the residual corrections compressed using a predetermined transform, to thereby obtain enhanced image data; resampling the enhanced image data based on the motion vector data to thereby obtain resampled enhanced image data; blending the resampled enhanced image data with the upsampled baseline image data to produce predicted image data; enhancing the predicted image data by applying to the predicted image data residual corrections, the residual corrections compressed using a predetermined transform, to thereby obtain resampled further enhanced image data; upsampling the resampled further enhanced image data to obtain further enhanced image data; and outputting the further enhanced image data for display.

According to a still further aspect of the present invention, a method is provided for decoding and enhancing a video image stream from an enhanced initial image frame and a bitstream containing at least sampled baseline image data and image enhancement data, comprising: separating the bitstream into blocks of sampled baseline image data and image enhancement data; upsampling the sampled baseline image data to produce a first image frame; determining motion vector data based on said first image frame; determining from the motion vector data mismatch image data; resampling the enhanced initial image frame based on the motion vector data to thereby obtain a resampled enhanced initial image frame; blending the resampled enhanced initial image frame with the first image frame, the blending control provided at least in part by the mismatch image data, to produce a predicted image; enhancing the predicted image by applying to the predicted image residual corrections, the residual corrections compressed using a predetermined transform, to thereby obtain an enhanced first image frame; and outputting the enhanced first image frame for display.

According to yet another aspect of the present invention, a method is provided for decoding and enhancing a video image stream from an enhanced initial image frame and a bitstream containing at least sampled baseline image data and image enhancement data, comprising: separating the bitstream into blocks of sampled baseline image data and image enhancement data; upsampling the sampled baseline image data to produce a first image frame; determining motion vector data from a portion of the image enhancement data resampling the enhanced initial image frame based on the motion vector data to thereby obtain a resampled enhanced initial image frame; blending the resampled enhanced initial image frame with the first image frame to produce a predicted image; enhancing the predicted image by applying correction data to individual pixels, control for the correction data comprising a set of weighted texture maps identified on a block-by-block or pixel-by-pixel basis by a portion of the image enhancement data, to thereby obtain an enhanced first image frame; and outputting the enhanced first image frame for display.

According to still another aspect of the present invention, a method is provided for decoding and enhancing a video image stream from an enhanced initial image frame and a bitstream containing at least sampled baseline image data and image enhancement data, comprising: separating the bitstream into blocks of sampled baseline image data and image enhancement data; adaptively upsampling the sampled baseline image data on a block-by-block basis to produce a first image frame, the adaptive upsampling controlled at least in part by a portion of the image enhancement data for each block; determining motion vector data based on said first image frame; determining from the motion vector data mismatch image data; resampling the enhanced initial image frame based on the motion vector data to thereby obtain a resampled enhanced initial image frame; blending the resampled enhanced initial image frame with the first image frame, the blending control provided at least in part by the mismatch image data, to produce a predicted image; enhancing the predicted image by applying correction data to individual pixels, control for the correction data comprising a set of weighted texture maps identified on a block-by-block or pixel-by-pixel basis by a portion of the image enhancement data, to thereby obtain an enhanced first image frame; and outputting the enhanced first image frame for display.

The above is a summary of a number of the unique aspects, features, and advantages of the present invention. However, this summary is not exhaustive. Thus, these and other aspects, features, and advantages of the present invention will become more apparent from the following detailed description and the appended drawings, when considered in light of the claims provided herein.

### BRIEF DESCRIPTION OF THE DRAWINGS

In the drawings appended hereto like reference numerals denote like elements between the various drawings. While illustrative, the drawings are not drawn to scale. In the drawings:

FIG. 1 is an overall system flow chart of the preferred embodiment of the decoder.

FIG. 2 is a system block diagram of an apparatus that embodies the flow chart of FIG. 1.

FIG. 3 is a flow chart detailing and upsampling process according to an embodiment of the present invention.

FIG. 4 is a flow chart detailing the motion estimation calculation for an up-sampled image according to an embodiment of the present invention.

FIG. 5 is a flow chart detailing motion compensation applied to enhanced images according to an embodiment of the present invention.

FIG. 6 is a flow chart detailing enhanced image forward motion compensation according to an embodiment of the present invention.

FIG. 7 is a flow chart detailing enhanced image backward motion compensation according to an embodiment of the present invention.

FIG. 8 is flow chart detailing the process for obtaining an enhanced image bidirectionally predicted image according to an embodiment of the present invention.

FIG. 9 is a flow chart detailing the residual decoder enhancement process according to an embodiment of the present invention.

FIG. 10 is a flow chart detailing base layer image up-sampling according to an embodiment of the present invention.

### DETAILED DESCRIPTION OF THE INVENTION

In one aspect of the present invention, a low-quality version of a video source, typically low resolution video sequence, is up-sampled and treated to provide a high-quality version of the video source, typically a high resolution video sequence. This process is generally referred to as spatial scalability of a video source. Scalable coding methods and systems according to various embodiments of the present invention take a low-quality video sequence as a starting point for creating a higher-quality sequence. In one example, the low-quality version may be standard resolution video and the high-quality version may be high definition video. One of ordinary skill in the art will readily understand that the present invention may be used for other applications in which additional information beyond the base video stream is used to enhance the resultant video stream. In one alternative example, additional information may be provided in an enhancement stream. The enhancement stream may carry, for example chrominance data relating to a high quality master version of the video sequence, where the base layer stream is just monochromatic (carries just luminance).

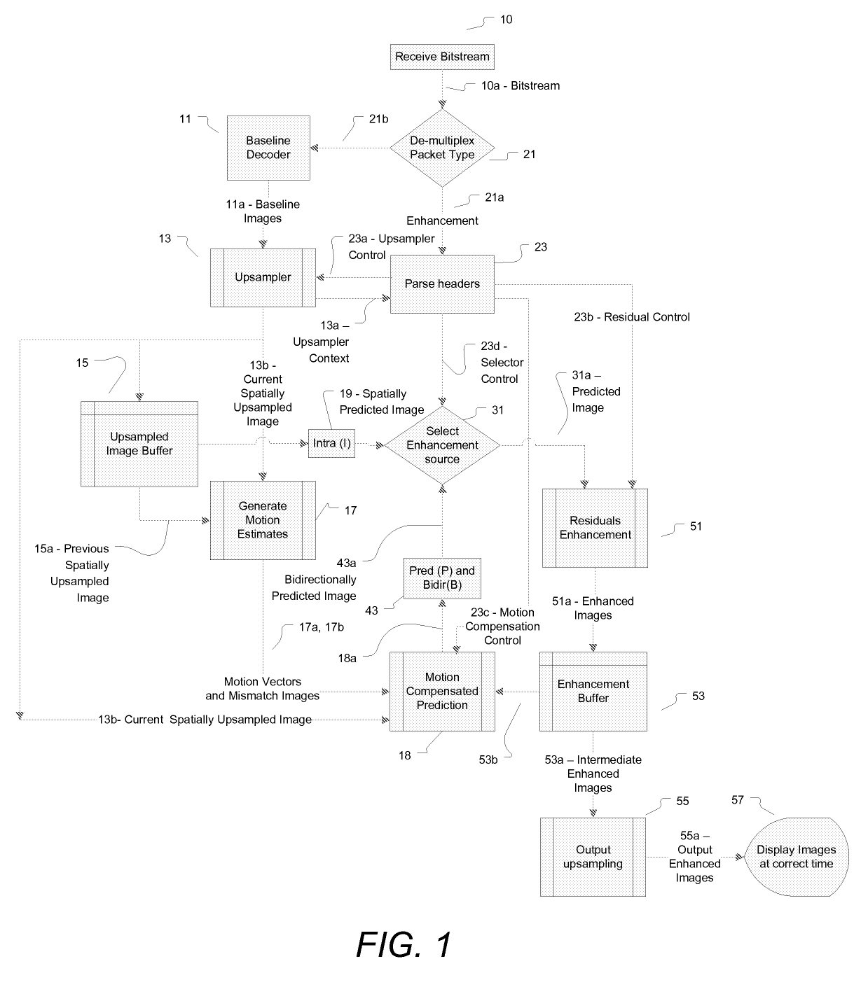

FIG. 1 is flow chart illustrating a number of steps according to one embodiment of the present invention. In FIG. 1, process, steps, functions, and the like are illustrated as elements of figure, and labeled numerically (e.g., the process of decoding the baseline image at step 11), while signals, images, data and the like are represented by arrows connecting elements, and are labeled with numbers and letters (e.g., the decoded baseline image 11a). There are two primary branches of the flow chart of FIG. 1; up-sampled image decoding (11, 13, 15, 17), and enhanced image decoding (31, 51, 53, 18, and 43). Baseline decoding produces low resolution video. Enhancement decoding operates on elements of the baseline image decoding (e.g., base layer video from 13 with motion estimation from 17), Baseline images to produce enhanced images (e.g. at step 51a). In the preferred method, the enhancement decoding guides these operations locally or block-wise, rather than across an entire image or image set, adaptively applying filters to produce an enhanced video stream rendition optimally approximating an original high resolution video stream. Also novel to the invention is the manner in which the decoder cycles enhanced images for reuse in motion compensation.

Briefly, both a baseline video stream and an enhancement stream are received in encoded format, on a packet basis. Demultiplexer 21 separates the two streams based on header information in each packet, directing the baseline video stream packets 21b to a decoder 11 and the enhancement packets to a parser 23. Decoder 11 decodes the baseline video stream and delivers baseline images 11 a to up-sampler 13. The decoded baseline video stream is then up-sampled, baseline images guided in part by the decoded enhancement stream 23a. Motion estimation is then applied to derive motion vectors 17a and mismatch images 17b, which are then utilized by portions of the enhancement decoding described below.

In the enhancement decoding branch of the flow chart, predicted images 31a are enhanced by a selected enhancement process at 51. At this point it should be noted that reference herein to “images” is intended in its broadest sense. While a video is typically divided into frames, images as used herein can refer to portions of a frame, an entire frame, or multiple frames. The enhanced images are buffered at 53 and made available to a motion compensation process 18 utilizing the aforementioned motion vectors 17a and mismatch images 17b from 17. By buffering the enhanced images at 53, a temporal selection of blocks of previously enhanced pixels are available for reuse as reference frames in subsequent construction.

The manner in which motion compensation is applied derives efficiency by using the decoded baseline images as a source. Up-sampled baseline images 15a are used to derive motion vectors 17a which are predictors applied to previously decoded enhanced images 53b to create motion compensated images 18a. Blending functions 43 are applied to these motion compensated enhanced images using both forward and backward prediction. Guided by a Selector Control 23d signal from the decoded enhancement stream, the selector 31 switches on a block-by-block basis between a block from the up-sampled image decoded block 19 or a motion predicted block 43a.

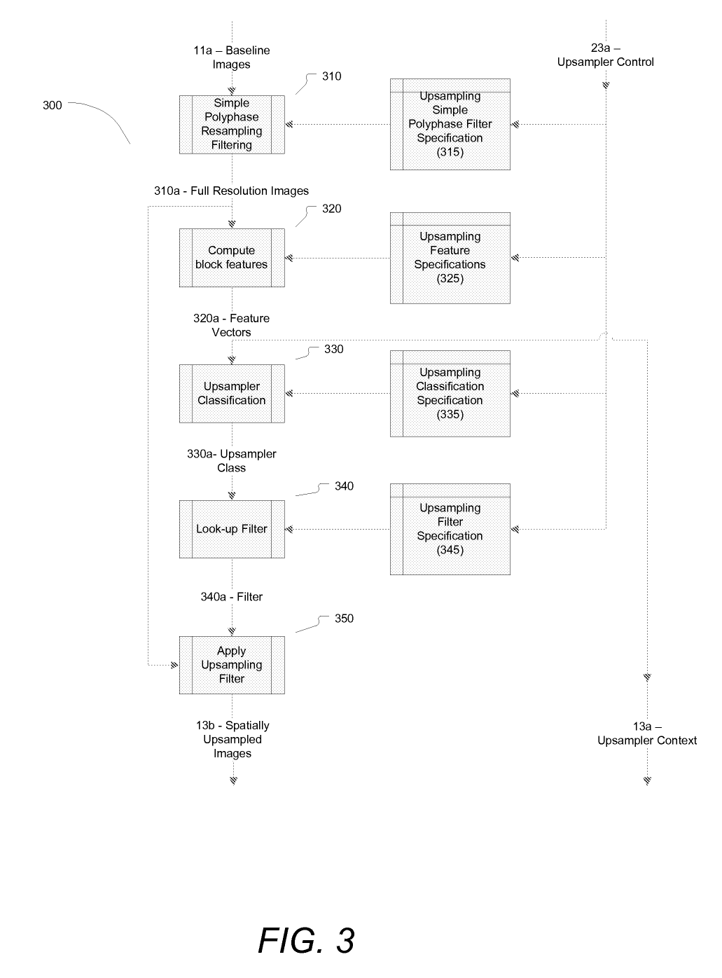

The baseline image decoder 11 produces standard resolution or baseline output images 11a which are up-sampled at up-sampler 13 in a manner directed by up-sampler Control 23a parsed from the enhancement stream. Further details of the preferred method for up-sampling are described hereinbelow with reference to FIG. 3. The up-sampled baseline images 13b are then stored in buffer 15 to serve as a reference for generating motion estimates by estimator 17 to be used for motion predictions as previously discussed.

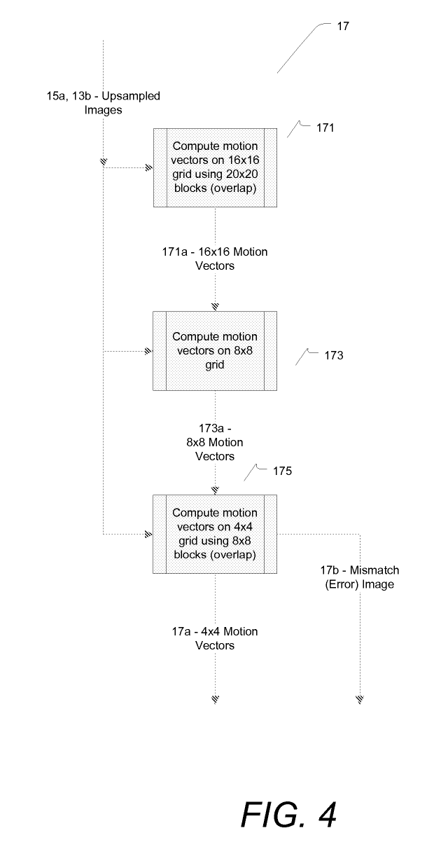

Motion vectors 17a which are derived from the up-sampled baseline images 13b provide the coordinates of image samples to be referenced from previously enhanced images 53. We have discovered that these provide the best motion predictors, as predictors derived from comparisons between the current up-sampled image and the previously enhanced images are not as accurate. Since the desired enhanced image is, at this point, being created by this process, predictors from the up-sampled baseline images serve as good estimates for the otherwise unobtainable ideal predictors from the enhanced images residing in the enhancement buffer 53. Additional motion prediction steps are detailed in FIG. 4.

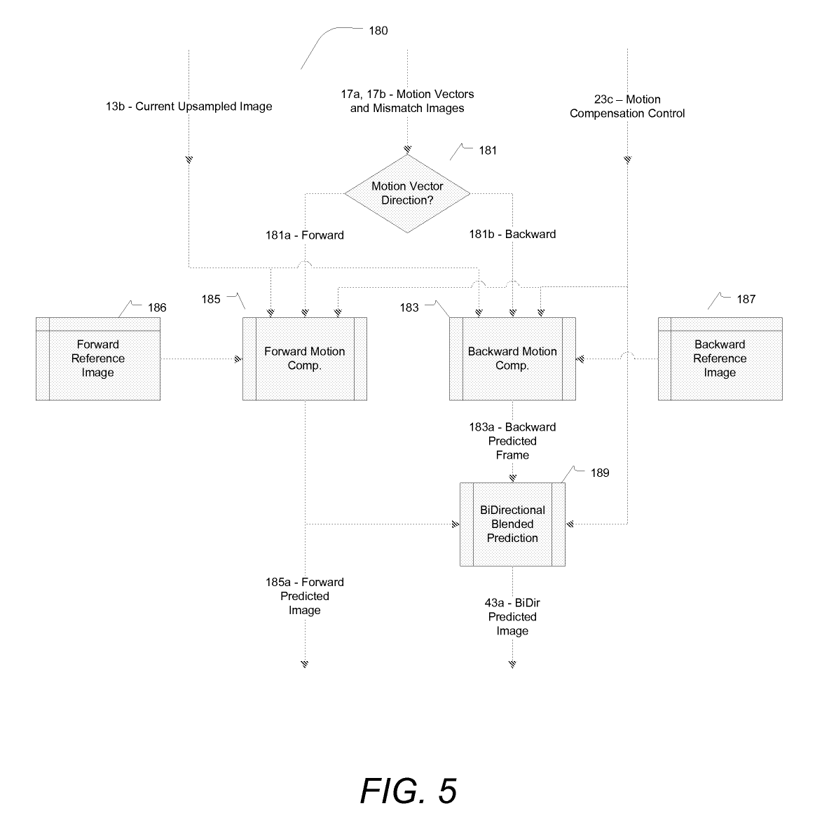

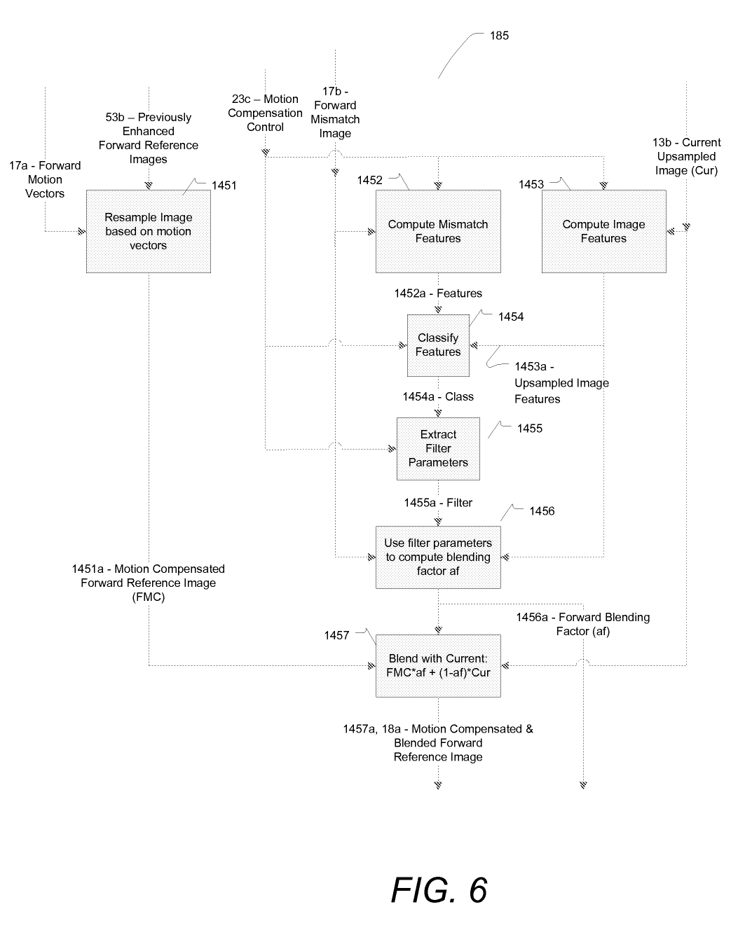

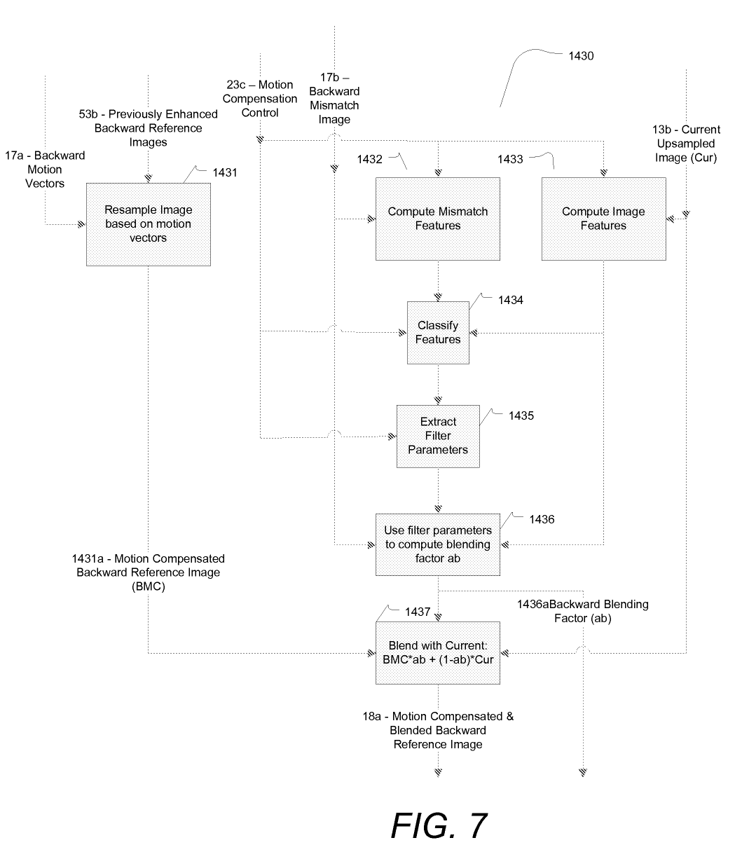

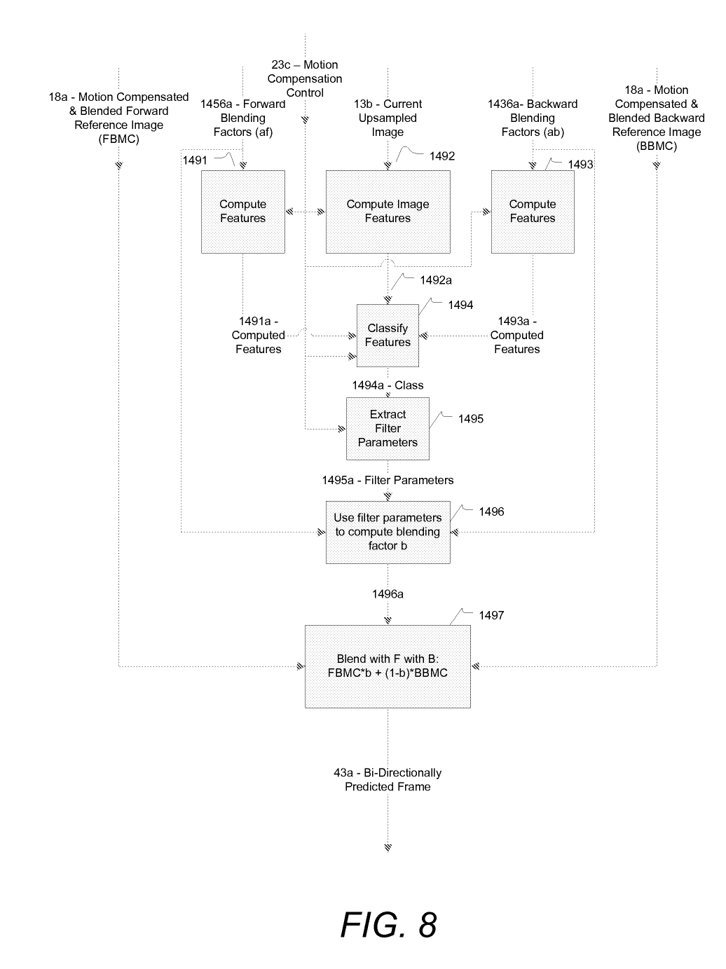

Using the coordinates derived from the motion vectors at 17, samples from enhancement buffer 53 are motion compensated at 18 to create predictors 18a, typically one for each forward and backward reference, that are combined at 43 to serve as a best motion predictor 43a for selection at 31. Additional motion compensation steps are detailed in FIG. 5, FIG. 6, FIG. 7, and FIG. 8.

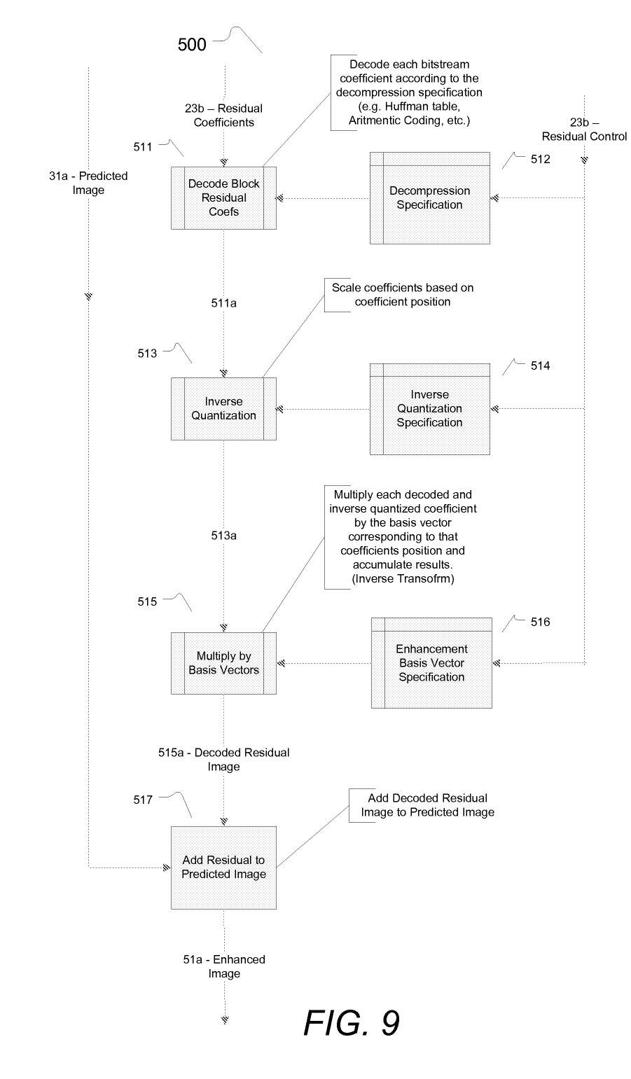

The selector 31 finally blends the best spatial predictor 19 as input with the best motion compensated temporal predictor 43a to produce the best overall predictor 31a. In the preferred embodiment, the blending function is a block-by-block selection between one of two sources, 19 or 43a, to produce the optimal output predicted images 31a. For a majority of blocks comprising the enhanced image, this predicted image 31a is often good enough. For those blocks that the predictor is not sufficient, further residual enhancement is added at 51 to the predicted image 31a to achieve the enhanced images 51a. Residual enhancement is directed by the enhancement stream's residual control 23b. Additional steps are detailed in FIG. 9. Enhanced images are buffered at 53 for at least two purposes: to serve as future reference in motion compensated prediction at block 18, and to hold images until they need to be displayed, as frame decoding order often varies from frame display order.

To increase bitrate efficiency and to match the resolution to the typical level of detail present in any content, the intermediate enhanced image 53a may be coded at a resolution slightly lower than the final output image 55a. Quality may be improved, and implementation is simplified, if for example, the coded enhanced image 53a is two times the size both horizontally and vertically to that of the baseline image 11a. A typical size is 720×480 for the baseline image, enhanced to a resolution of 1440×960, and then resampled to a standard HDTV output resolution grid of 1920×1080.

In summary, the enhancement image branch of the flowchart (from 31a to 53a/b) is primed first by the up-sampled baseline images 13b via the path 13b to 15 to 19, and continually primed by subsequently up-sampled baseline images. From there, enhancement images are cycled through the enhancement branch and modified by predictors derived from up-sampled baseline image sets. Selection is guided by the selector control 23d as is residual enhancement 23b. Residual enhancement is added in where selected (either spatial or temporal) predictors are not adequate, as indicated by the enhancement stream and as predetermined at the encoder.

### Apparatus

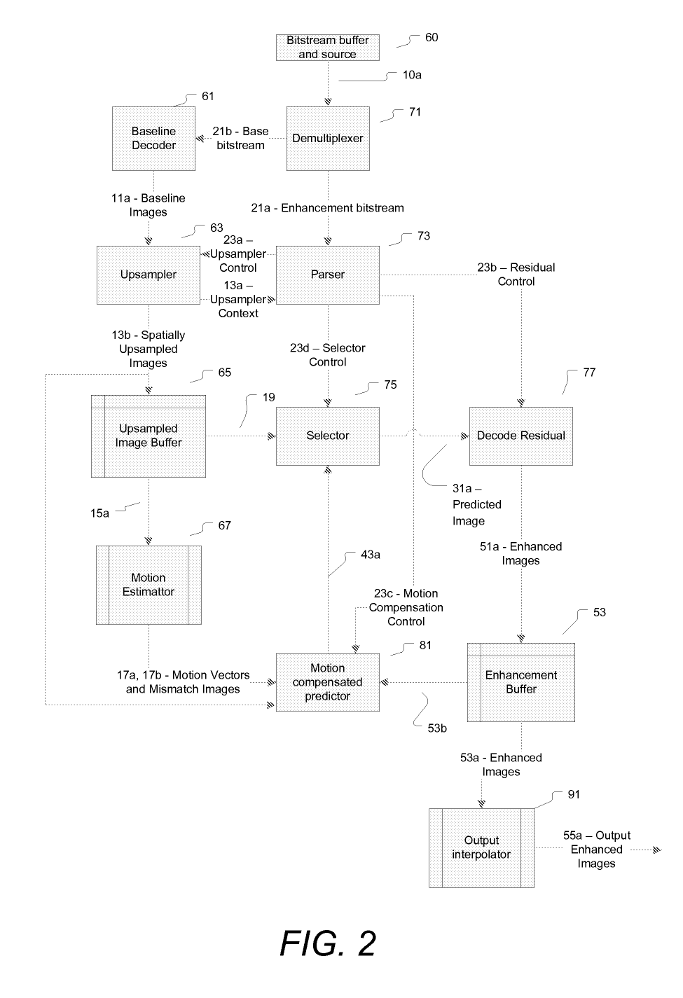

FIG. 2 shows an apparatus according to one embodiment of the present invention. An apparatus according to the present invention may be realized as a combination of Digital Signal Processors (DSPs), Application Specific Integrated Circuits (ASICs), general purpose CPUs, Field Programmable Gate Arrays (FPGA), and other computational devices common in video processing. Most of the key and computationally intensive enhancement layer stream tools according to the present invention such as motion estimation, image up-sampling, and motion compensation, may be highly pipelined into discrete parallel block stage processing pipelines. The selection stage 75 consists of denser, more serially-dependent logic, with feedback to the parser to affect the syntax and semantic interpretation of token processing over variable time granularities, such as blocks and slices of blocks.

A bitstream buffer 60 holds data packets received 10 from a communications channel or storage medium, which are buffered out at 10a and demultiplexed 21 by the demultiplexer 71 to feed the enhancement and baseline image decoding stages with bitstream data 21a, 21b as said data is needed by the respective decoding stages.

A baseline decoder 61 processes a base bitstream 21b to produce decode baseline images 11a. This decoder can be any video decoder, including any but not limited to the various standard video decoders such as MPEG-1, MPEG-2, or MPEG-4, or MPEG-4 part 10, also known as AVC/H.264.

A parser 73 isolates stream tokens 23a, 23b, 23c, and 23d packed within the enhancement bitstream 21a. Tokens needed for enhancement decoding may be packed by token type, or multiplexed together with other tokens that represent a coded description of a geometric region within an image, such as a neighborhood of blocks. Similar to MPEG-2 and H.264 video, one advantageous method according to the present invention packs tokens needed for a given block together to minimize the amount of hardware buffering needed to hold the tokens until they are required by decoding stages.

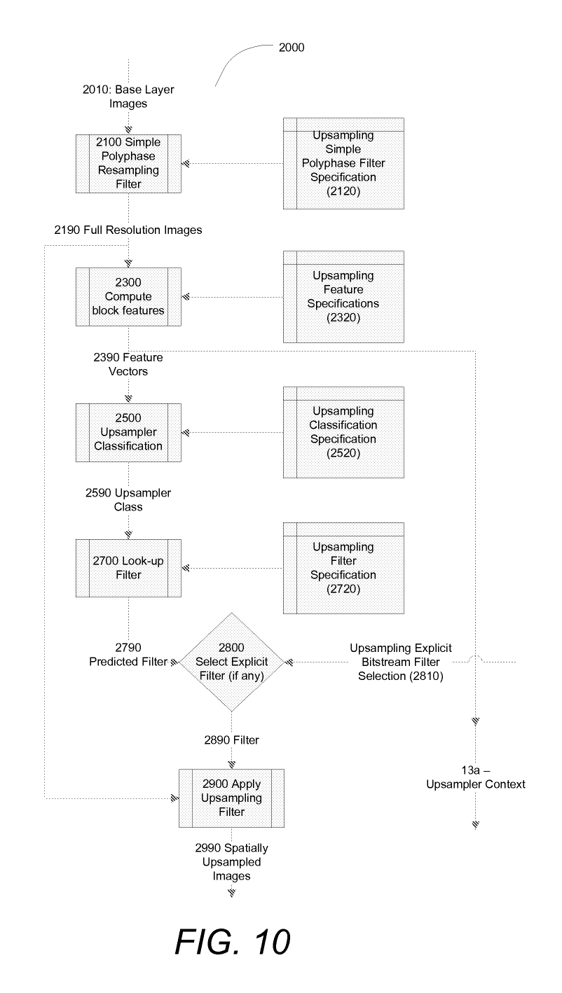

These tokens may be coded with a variable-length entropy coder that maps the token to a stream symbol with an average bit length approximating the probability of the token; more specifically, the bit length is proportional to −log 2 (probability). The probability or likelihood of a token is initialized in the higher level picture headers and further dynamically modeled by explicit stream directives (such as probability resets or state updates), the stream of previously sent tokens, and contexts such as measurements taken inside the decoder state. Features 13a (discussed further below with regard to FIG. 10) derived in the up-sampler 63 and mismatch features 17b derived in the motion estimator 67 set context probabilities in a manner similar to context models in the H.264 CABAC coder. Specifically, an upsampler control 23a variable sent in the picture header sets the level thresholds in which the variance feature measured over a block shall be quantized to pick a probability table used in the entropy coding of the enhancement layer stream block mode selection token. The variance measurement, along with other features 13a, serves as variables in formulas selecting probabilities and predictors for other tokens within the enhancement layer bitstream 21a. These formulas relate the correlation of measurement to modes signaled by tokens, or otherwise inferred.

Upsampler 63 processes baseline images 11a in accordance with the upsampler control 23a. These control signals and functions are described in more detail in FIG. 3. The basic function of this unit is to convert images from the original lower-quality baseline representation to the higher-quality target representation. Usually this involves an image scaling operation to increase the number of pixels in the target representation. The resulting spatially upsampled images 13b are generated by an adaptive filtering process where both the manner of the adaptivity and the characteristics of the filters are specified and controlled by the upsampler control 23a. Adaptivity is enabled by way of image feature analysis and classification of the baseline image 11a characteristics. These features 13a are transferred to the parser 73 to influence the context of parsing the enhancement bitstream 21a. The features are further processed by the upsampler 63 via a process called classification which identifies image region characteristics suitable for similar processing. Each image region is therefore assigned to a class, and for each class there is a corresponding filter. These filters may perform various image processing functions such as blurring, sharpening, unsharp masking, etc. By adaptively applying these filters to differently characterized image regions, the upsampler 63 can soften some areas containing compression artifacts while sharpening other areas, for example, containing desired details. All of this processing is performed as directed by the enhancement bitstream and pre-determined enhancement algorithms.

A motion estimator 67 analyzes the current upsampled image, and the previously upsampled version of the forward and backward reference images stored in the upsampled Image Buffer 65. This analysis consists of determining the motion between each block of the current upsampled image with respect to the reference images. This process may be performed via any manner of block matching or other similarity identification mechanisms which are well known in the art and which result in a motion vector indicating the direction and magnitude of relative displacement between each block's position in the current frame and its correspondingly matching location in the reference frame. Each motion vector therefore can also be associated with a pixel-wise error map reflection the degree of mismatch between the current block and its corresponding block in each reference frame. These motion vectors 17a and mismatch images 17b are then sent to the Motion Compensated predictor 81.

A motion compensated predictor 81 receives the current spatially upsampled image 13b together with enhanced images 53b to produce a blended bidirectionally predicted frame 43a as directed in part by the motion vectors 17a and mismatch information 17b.

A selector 75 picks the best overall predictor among the best sub-predictors, including up-sampled spatial 19 and temporal predictors 43a. The selection is first estimated by context models and then finally selected by block mode tokens 23d, parsed from the enhanced video layer bitstream 21a. If runs of several correctly estimated block modes are present, a run length token optionally is used to indicate that the estimated mode is sufficient for enhancement coding purposes and no explicit mode tokens are sent for those corresponding blocks within the run. A residual decoder 77 provides additional enhancements to the predicted image 31a as guided by a residual control 23b. A detailed description of the process used within the Decode Residual 77 block is detailed below (FIG. 9).

### Up-Sampling Method

Returning now to FIG. 1, in one example embodiment, an up-sampler 13 is provided for converting standard definition video images to high resolution images. In general, adaptive up-samplers may provide a huge initial image quality boost (from 1 to 3 dB gain for less than 10 kbps) but their advantages are limited. An encoder according to the present invention identifies which areas can be enhanced the most simply by improving image filtering in the up-sampling process. Then the encoder determines what types of similar low-resolution image features characterize areas that may be best enhanced with the same filters.

With reference now to FIG. 3, the preferred method 300 for up-sampling baseline images (as performed on baseline images 11a at step 13 of FIG. 1, for example) is presented. This method relies on an adaptive filter that operates on an image according to feature classification of individual blocks within that image. Therefore, all blocks within an image 11a are classified. Briefly, a filter is selected from a set of filters and applied 350 to a block according to its classification. In the preferred embodiment, the enhancement stream provides the set of filters that are applied on a block by block basis and also provides the classification method. Optionally, the image bitstream may also specify block size; otherwise block size is understood to be fixed in the decoder. It is not a requirement that all of the blocks are to be operated upon by a filter.

More specifically, baseline images 11a are input to a simple polyphase resampling filtering 310 process which produces full resolution images 310a, equivalent in resolution to enhanced images (51a from FIG. 1). There may be a default or predefined set of filters used in the simple polyphase resampling 310 or a set of filters may transmitted within the bit stream (10a in FIG. 1). The normal implementation of the simple polyphase resampling 310 is applied horizontally and then vertically in a pipelined fashion. This process presents no sharpening effects, as all pixels are up-sampled to produce a uniformly equivalent output image 310a.

Next, features are computed at step 320 from the full resolution images 310a on a block by block basis. In the preferred embodiment, block size is 8×8, however, block size may be image dependent. Block features may include average pixel intensity (luminance) wherein the average of all pixels within the block is computed. Another useful feature is variance. Here, the absolute value of the difference between the overall image average pixel intensity and each pixel within a block is summed to produce a single number for that feature of the block. The output of the compute block feature 320 is the feature vector 320a which represents an ordered list of features for each block in an image.

The up-sampler classification process 330 is provided by the bitstream (10a shown in FIG. 1) to reduce the feature vectors 320a into a small set of classes. Classification parameters are sent in the enhancement bitstream 23a as are the filters As example of a classifying, average intensity may be reduced into a set of three classes such as low, medium, and high average intensity. One simple method of reducing a wider ranging scalar values (typically 0-255) into one class of three consists of adding a number, dividing by another number, and then taking the integer portion as the feature class such that the reduced scalar values 0, 1 and 2 numerically represent the possible range. The same method may be applied to variance. Any one of a number of classification methods known in the art such as Table (lattice), K-means (VQ), or hierarchical tree split may be applied to the set of feature vectors 320a to produce a limited number of feature classes. The result of this classification 330 is the up-sampler class 330a.

Next, the up-sampler class 330a is input into a look-up filter at step 340, which outputs a filter 340a for that class. This filter is selected by class and applied as a predetermined weighted sum over neighboring pixels to produce the best match to the expected output of the source video stream. The filter 340a corresponding to a particular class is then applied 350 to the pixels 310a in the block belonging to that class, producing spatially up-sampled images 13b. Note that it is mathematically feasible to combine the filter 340a's weighted values with the weights used in the simple polyphase resampling 310, thus combining steps 310 and 350. The preferred embodiment keeps these stages separate for design reasons.

In summary, the up-sampling method computes image features on a block basis, classifies the feature vectors into a small number of classes as directed by the enhancement stream, and identifies a class for each block within the image. Corresponding to each class is a specific filter. The method applies the corresponding filter to the pixels of the classified block. The filters which are typically sharpening filters, are designed for each class of blocks to give the best match to the expected output or the original source video stream.

### Residual Decoder Method

FIG. 9 shows a flow chart for a process 500 that may occur in the residual decoder (77 in FIG. 2). The input for process 500 is the demultiplexed 21a and parsed 23b bitstream as well as the predicted image 31a. Stream tokens 23b are decoded at step 511, utilizing the decompression specification 512 (e.g., Huffman table, Arithmetic Coding, etc.) to obtain residual coefficients 51 la that represent quantized magnitudes of spatial patterns. This step can be combined with the step of parsing (shown as performed by block 73 in FIG. 2), or if outside the parser, is typically a stage within the residual decoder 77 that has temporary access to the packed bitstream tokens to perform decode and parsing on its own (until it reaches the end of a contiguous set of coefficient tokens). Process 500 may alternatively provide feedback to the parser (73, FIG. 2) to advance the bitstream cursor to the next valid token within the bitstream, or advance state of a more general variable length machine such as implemented in the H.264 standard CABAC entropy decoder.

Inverse quantization is next performed at step 513, based upon the quantization specification determined at step 514 from the data headers, to expand the residual coefficients 511a to the full dynamic range of dequantized coefficients. The coefficient is then multiplied by enhancement basis vectors at step 515 from an enhancement basis vector specification determined at step 516 from the data headers to obtain difference data, the residual decoded image 515a. As an alternative to determination from data headers, the decompression specification, inverse quantization specification, and enhancement basis vector specification may be preset in the decoder. The residual decoding steps 511, 513, and 515 therefore transform parsed compact stream token in bitstream 23b into de-compressed difference samples which comprise the residual data 515a. Predicted image 31a may then be added to the residual data 515a at step 517. This step 517 of adding enhancement to the raw image follows traditional addition arithmetic with saturation found in many reconstruction stages that combine prediction data with residual data to form the final reconstructed data.

Optionally, each residual decoder step 511, 513, 515, and 517 may also be fed Up-sampler Control 23a from the parser (73 of FIG. 2 and step 23 of FIG. 1) that initializes or guides internal states and tables within each residual stage. Returning to FIG. 2, enhanced images 51a are stored in a frame buffer 53, preferably maintained in Dynamic Random Access Memory (DRAM), SRAM, fast disk drive, etc. connected to the video processing device.

The motion estimator 67 finds the best temporal predictor referenced from previously stored spatial predictor images in up-sampled image buffer 65. Although accurate optical flow field measurements are desirable, the preferred motion estimation steps provide a good approximation to true single motion vector per pixel accuracy.

FIG. 4, a flow chart detailing one embodiment of process 17 from FIG. 1, represents the preferred method of generating motion predictors 17a and mismatch images 17b from spatially up-sampled images 15a and 13b. These are later used to create the current motion compensated frames, specifically the forward and backward predicted images 18a.

As shown in the flow chart in FIG. 4, a first motion vector may be computed at step 171 for a target block size, advantageously dimensioned at 16×16 pixels. Alternative block dimensions, for example of 32×24, 20×20, 8×8, 4×4 pixels, or the like, are encompassed within the scope of the present invention. Samples along the boundary of the block contribute to the matching to better constrain a fit to image context—this is a criterion in the traditional optical flow problem. Two overlap pixels extend the primitive block size to 20×20 pixels in the case of a 16×16 pixel block. This extended dimension is applied for reference blocks, formed by half-pel and quarter-pel or other coordinate precision, to match the target 16×16 with a similar extension to a 20×20 block shape. This process, known as overlapped block matching, provides for more consistent motion vectors from one block to the next. Motion vector coordinates 171a point to the ideal location of the best 16×16 block match to the target 16×16 block.

The motion vector 171a relating the 16×16 block area is used to initialize the block search for each of four 8×8 blocks split in equal quadrants from the single 16×16 block. The 16×16 motion vector 171a is scaled to the appropriate coordinate grid of the 8×8 block and serves as a starting point for the 8×8 refinement search 173.

A scaled and adjusted version of the 8×8 vector 173a in turn initializes the search 175 for each of the four 4×4 blocks split from the single 8×8 block. Due to the small size of the block, which lends the block search to a false optical match (but potentially minimum numerical match), a large overlap (relative to the small size of the block) of two border pixels is added to constrain the block match to a better contextual fit, in a similar manner to the overlap in 171. The 4×4 shape is considerably close to the ideal single-vector per pixel to produce results closely approximating a true optical flow field in many cases.

The resulting motion vectors 17a for each 4×4 block are passed onto the motion compensator stage 18. The mismatch image 17b produced as a by-product of the matching algorithm is used in feature calculations as discussed below with regard to FIG. 6. The mismatch image 17b is generated as a per pixel difference between the motion compensated pixels in a first reference image 15a and the target pixels of a second reference image 13b.

### Compensation and Blending

FIG. 5. is a flow chart of process 180, providing further detail of motion compensation 18 and blending 43 as represented in FIG. 1. To construct a bidirectionally predicted image, two reference images are used, the forward reference image 186 and the backward reference image 187. As previously defined hereinabove, the terms forward and backward are applied as standard nomenclature in the process of image motion prediction and compensation to define two distinct images, but they are not necessarily temporally before and after the current image being processed.

The forward 186 and backward reference images 187 reside in the enhancement buffer (53 as referred in FIG. 1). Pixels from these images may be randomly accessed to construct the final output bidirectionally predicted image 43a. The motion compensation and blending process is dictated by the motion vectors and mismatch images 17a, 17b together with filter and classification methods which may be locally defined or dynamically passed from the enhancement bitstream 21a by way of motion compensation control 23c.

Beginning at the top of FIG. 5, motion vectors 17a and mismatch images 17b from each of forward and backward reference images are input at step 181 and separated at its output 181a and 181b. Forward motion vectors and forward mismatch image 181a are input at the forward motion compensation step 185. This step also receives two images; the corresponding forward reference image 186 and the current up-sampled image 13b. By applying the forward motion vectors and forward mismatch image, the two input images 186 and 13b are combined to produce an output, forward predicted image 185a. Motion compensation control 23c from the enhancement bit-stream 21a overrides inaccurate motion vectors. This forward motion compensation process is further detailed in FIG. 6, discussed below.

Similarly, the backward motion vectors and mismatch image 181b are input to backward motion compensation step 183. This step also receives two images; the corresponding backward reference image 187 and the current up-sampled image 13b. By applying the backward motion vectors and backward mismatch image, the two input images 187 and 13b are combined to produce an output, backward predicted image 183a. Motion compensation control 23c from the enhancement bit stream 21a overrides inaccurate motion vectors. The output, backward predicted image 183a, together with the forward predicted image 185a, are input to the bi-directional blended prediction 189, which produces the final output bi-directional predicted image 43a. A detail of the backward motion prediction process (FIG. 7), and the bi-directional blended prediction process 189 (FIG. 8) is provided herein below.

Referring now to FIG. 6 detailing forward motion compensation 185, a motion compensated and blended forward reference image 1457a is produced. In general, this process chooses between a temporally predicted enhanced image 53b and a spatially predicted up-sampled image 13b, and blends these images on a pixel by pixel basis to produce the best match to the expected output. Given that in general, the motion compensated forward reference image 53b is sharper and the motion prediction is accurate, this process would preferentially choose the motion prediction pixels. If however, the motion predicted image isn't accurate, then the spatially predicted image pixels are chosen. The process also uses a blending factor 1456a computed in 1456 which provides a filter applied to in step 1457 to the two source pixels (1451a, 13b) to produce a weighted sum output pixel (1457a, 13b). Feature generation 1452 and classification 1454 processes operate on a block by block basis to compute the blending factor 1456 that is applied to each pixel within a block.

As FIG. 4 detailed the process of computing motion vectors 17a and mismatch image 17b, this data is now applied in FIG. 6 to produce a motion compensated forward reference image 1451a by resampling in step 1451a previously enhanced forward reference image 53b guided by vectors 17a. The forward mismatch image 17b is then used to compute mismatch features at step 1452 as the first step of the process of determining the forward blending factor 1456a. The forward mismatch features 1452a are computed on a block by block basis and may include the average error in a block and the error gradient of the block.

Likewise for the spatially predicted image, step 1453 of computing image features is applied to the current up-sampled image 13b. The up-sampled image features 1453a, also computed on a block by block basis, may include average pixel intensity or brightness level, average variance, or the like. For each block, up-sampled image features 1453a and mismatch features 1452a are input to classify features step 1454 and converted into one of a small set of classes 1454a. For example, a set of 32 classes may be composed of five bits of concatenated feature indices having the following bit assignments:
bit 0-bit 1: Up-sampled Image Block brightness variance
bit 2: Up-sampled Image Block average brightness >85
bit 3-bit 4: Forward Mismatch Image average of absolute values.

The output class 1454a is used at step 1455 to select an optimally defined filter to be applied to the block so classified. Both the class definitions that determine the manner of classification at step 1454 and the filter parameters at step 1455 that are assigned to each class may be embedded in the received bitstream 10 at the decoder input. There is a one to one correspondence between classes 1454a and filters 1455a.

Whereas classic decoders require signaling on a block by block basis to combine two images, the method according to the present invention applies automated decoder-based feature extraction and classification to blend two images, thereby reducing signaling requirements as well as providing blending. The filter 1455a is now input to the step 1456 of using filter parameters to compute the blending factor. Also input are the forward mismatch image 17b and up-sampled image features, such as per pixel variance, 1453a which influence the block based filter 1455a at the pixel level in order to adjust the forward blending factor (FMC) 1456a for each pixel. Factor 1456a is input to step 1457 in order to blend with current FMC*af+(1−af)*current up-sampled image 13b, so that the blending factor together with the corresponding pixels from motion compensated reference image 53b and current up-sampled image 19 may be blended to produce the final output motion compensated and blended forward reference image 1457a.

An example method of describing a filter 1455a according to a block's class 1454a, considering that image variance as a feature 1453a in the current up-sampled image 13b contributes two high order bits to the class 1454a output after processing in step 1454, would be described as:

{00xx=low variance, 01xx=moderately low variance, 10xx=moderately high variance, 11xx=high variance}.

Variance suggests texture in a block which may be true to the original source image or may be an artifact of the encoding and decoding process. Now consider the other source image, motion compensated forward reference image 53b. It's corresponding mismatch image feature 17b also contributes two low order bits to the class 1454a output after processing in step 1454, and would be described as:

{xx00=low mismatch, xx01=moderately low mismatch, xx10=moderately high mismatch, xx11=high mismatch}.

The mismatch image 17b feature is considered together with the variance to determine weighting or a blending factor between the two source images. For example, if the variance index is low and the mismatch index is high, the class is 0011. It is likely that the filter for this class will be one such that for pixels with moderate levels of mismatch the generated filter value af will have a value close to zero, thereby generating an output pixel value predominantly weighted toward the current up-sampled image 13b. With the same filter, if the mismatch pixel value is very small, the filter generated weighting value af my be closer to 1.0, thereby generating an output pixel value predominantly weighted toward the forward motion compensated image 53b. Conversely, if the variance index is high and the mismatch index is low, the motion compensated forward reference image 53b would predominate. Degrees of blending are selected for the intermediate indices. Also, we have found that an average block intensity index of the current up-sampled image 13b improves the reliability and accuracy of choosing an optimal blending factor.

The flow chart of FIG. 7 reflects process 1430, which is identical to the process of FIG. 6 except that backward prediction parameters are input along with the current up-sampled image 13b. Specifically, the backward motion vectors 17a, previously enhanced backward reference image 53b, and backward mismatch image 17b are input. By the same process as detailed for FIG. 6, motion compensated and blended backward reference image 18a is obtained.

Referring now to the flow chart of FIG. 8, motion compensated and blended forward and backward reference images 18a are blended to produce a bi-directionally predicted image 43a. Similar to FIGS. 6 and 7, the method described herein computes blending factors based upon image features that prescribe preference of one source image over another. Forward blending factors af 1456a and backward blending factors ab 1436a indicate this preference to the forward reference image 1451a and the backward reference image 1431a, respectively, if either of the values of these factors are approximately equal to one. If the values are approximately equal to zero, then the current up-sampled image 13b was preferred during the previous blending stage. This process however, determines blending between the forward and backward motion compensated and blended reference images 18a based upon the greater of the two blending factors af and ab. In the case of ambiguity, such as af=ab or af and ab are relatively small compared to one, then features of the current up-sampled image 13b are applied to generate a more complex set of filter parameters for computing the blending factor b.

The preferred method computes features 1491, 1492, and 1493 on a block basis. Forward computed features 1491a and backward computed features 1493a may incorporate the average value of af and ab respectively for each block. Brightness average and variance may be two computed image features 1492 applied to the current up-sampled image 13b. These three sets of features are input to step 1494 which classifies the features similar to feature classification discussed in previous examples, to produce a class 1494a. From this class 1494a input, filter parameters are extracted at step 1495 reflecting image blending preferences exhibited by the feature classification 1494. Next, the filter parameters 1495a are input to step 1496 which uses the filter parameters to compute the blending factor b, together with per pixel values for af 1456a and ab 1436a to produce the per pixel blending factors b. In the final step 1497, the two input images forward and backward motion compensated and blended reference images 18a are blended on a pixel by pixel basis according to the computed blending factor b, 1496a, producing the final output bi-directionally predicted image 43a. Note that FMBC=18a and BBMC=18a as illustrated in step 1497.

Referring to FIG. 10, an alternative up-sampler 2000 is described in which explicit bitstream control is applied to filter selection 2800. Referring to process 2000, this processing stage takes as input baseline images 2010 and produces spatially up-sampled images 2990 as output. Processing controls are provided by one or more of the following: up-sampling simple polyphase filter specifications 2120, up-sampling feature specifications 2320, up-sampling classification specifications 2520, up-sampling filter specifications 2720, and upsampling explicit bitstream filter selections 2810. A simple polyphase resampling filter 2100 scales from source resolution to destination resolution using a filter specified in the bitstream (up-sampling simple polyphase filter specification 2120). This could be a filter designed according to standard signal processing techniques (windowed sinc function) or it could be a simple pixel replication filter. This resampling process may be folded into the feature computations in stage 2300 and convolved with the “up-sampling filter” used in stage 2900 as discussed below.

A compute block features 2300 process may comprise computing various block features such as for example: variance, average brightness, etc. The features to be computed may be explicitly controlled by the up-sampling feature specifications 2320 in the bitstream. The features taken together may be referred to as a feature vector.

In a further stage, the process performs up-sampler classification 2500. This stage assigns an up-sampling class 2590 to each feature vector 2390. The classification process is specified in the enhancement bitstream as the up-sampling classification specification 2520 and may consist of one or more of the following mechanisms: Table (lattice), K-means (VQ), hierarchical tree split, etc.

In a look-up filter 2700 process, each class has an associated filter or filters that may be H&V, or 2D, or non-linear edge adaptive. This is delivered in the bitstream as the up-sampling filter specification 2720. An explicit filter may optionally be selected at 2800. If the up-sampling explicit bitstream filter selection 2810 is in the bitstream, then it overrides the classified feature based filter. If this filter is one that corresponds to a classified filter, then this signal could be sent one stage earlier as an up-sampling explicit bitstream class selection (not shown).

Finally, an up-sampling filter 2900 is applied. In this step, the process may apply a filter, such as for example a sharpening filter, to an already up-sampled image. This avoids polyphase resampling. The filter is applied on the base image by applying polyphase resampler and sharpening filter all at once.

While a plurality of preferred exemplary embodiments have been presented in the foregoing detailed description, it should be understood that a vast number of variations exist, and these preferred exemplary embodiments are merely representative examples, and are not intended to limit the scope, applicability or configuration of the invention in any way. For example, it will be appreciated that while a method and device have been disclosed that contain a plurality of novel elements, any one of such novel elements described herein, such as the method of adaptive upsampling, the methods of residual coding, decoder-based motion estimation and compensation, or adaptive blending, may form the basis for a novel decoder method and system. In such a case, for example, other elements of a decoding method and system may be those known in the art. Likewise select combinations of those novel elements disclosed herein may form a portion of a novel method and system for decoding, as appropriate to a particular application of the present invention, the remaining elements being as known in the art. Therefore, the foregoing detailed description provides those of ordinary skill in the art with a convenient guide for implementation of the invention, and contemplates that various changes in the functions and arrangements of the described embodiments may be made without departing from the spirit and scope of the invention defined by the claims thereto.

What is claimed is:

1. A method for decoding and enhancing a video image stream from a bitstream containing at least sampled baseline image data and image enhancement data, comprising:
separating the bitstream into blocks of sampled baseline image data and image enhancement data;
adaptively upsampling the sampled baseline image data on a block-by-block basis to produce upsampled baseline image data, the adaptive upsampling controlled at least in part by a portion of the image enhancement data for each block;
enhancing the upsampled baseline image data by applying to the upsampled baseline image data residual corrections, the residual corrections compressed using a predetermined transform, to thereby obtain enhanced image data; and
outputting the enhanced image data.

2. The method of claim 1, wherein the step of adaptively upsampling the sampled baseline image data further comprises, for each block of data, the steps of:
determining from the image enhancement data a polyphase filter specification for that block; and
producing, using the determined polyphase filter specification a full resolution image data set for that block.

3. The method of claim 2, further comprising the steps of:
determining from the image enhancement data an upsampling feature specification for that block; and
producing, using the determined upsampling feature specification a feature vector set for that block.

4. The method of claim 3, further comprising the steps of:
determining from the image enhancement data an upsampling classification specification for that block; and
producing, using the determined upsampling classification specification and the feature vector set for that block an upsample class for that block.

5. The method of claim 4, further comprising the steps of:
determining from the image enhancement data an upsampling filter specification for that block; and
producing, using the determined upsampling filter specification an upsample filter for that block.

6. A method for decoding and enhancing a video image stream from a bitstream containing at least sampled baseline image data and image enhancement data, comprising:
separating the bitstream into blocks of sampled baseline image data and image enhancement data;
adaptively upsampling the sampled baseline image data on a block-by-block basis to produce upsampled baseline image data, the adaptive upsampling controlled at least in part by a portion of the image enhancement data for each block;
determining motion vector data from a portion of the image enhancement data;
enhancing the upsampled baseline image data by applying to the upsampled baseline image data residual corrections, the residual corrections compressed using a predetermined transform, to thereby obtain enhanced image data;
resampling the enhanced image data based on the motion vector data to thereby obtain resampled enhanced image data;
blending the resampled enhanced image data with the upsampled baseline image data to produce predicted image data;
enhancing the predicted image data by applying to the predicted image data residual corrections, the residual corrections compressed using a predetermined transform, to thereby obtain resampled further enhanced image data;
upsampling the resampled further enhanced image data to obtain further enhanced image data; and
outputting the further enhanced image data for display.

7. The method of claim 6, further comprising the steps of:
determining from the predicted image data a selected upsampling filter; and
wherein the step of upsampling the resampled further enhanced image data further comprises utilizing the selected upsampling filter to obtain the enhanced output data.

8. A method for decoding and enhancing a video image stream from an enhanced initial image frame and a bitstream containing at least sampled baseline image data and image enhancement data, comprising:
separating the bitstream into blocks of sampled baseline image data and image enhancement data;
upsampling the sampled baseline image data to produce a first image frame;
determining motion vector data based on said first image frame;
determining from the motion vector data mismatch image data;
resampling the enhanced initial image frame based on the motion vector data to thereby obtain a resampled enhanced initial image frame;
blending the resampled enhanced initial image frame with the first image frame, the blending control provided at least in part by the mismatch image data, to produce a predicted image;
enhancing the predicted image by applying to the predicted image residual corrections, the residual corrections compressed using a predetermined transform, to thereby obtain an enhanced first image frame; and
outputting the enhanced first image frame for display.

9. The method of claim 8 wherein the step of blending the resampled enhanced initial image frame with the first image frame is additionally under the control of the image enhancement data.

10. The method of claim 8, wherein:
the step of determining motion vector data based on said first image frame is performed on a block-by-block basis, and further comprises performing overlapped block matching such that consistent motion vectors are provided from one block to the next.

11. The method of claim 10, wherein motion vector data comprises:
position data for each 4 pixel by 4 pixel block, which is determined from position data for a target block size is 16 pixels by 16 pixels, which is used to initialize a block search for each 8 pixel by 8 pixel block making up the 16 pixel by 16 pixel block, which in turn is used to initialize a block search for each 4 pixel by 4 pixel block making up the 8 pixel by 8 pixel block.

12. The method of claim 8, wherein the mismatch image data is determined as a per-pixel difference between pixels of the first image frame and corresponding pixels of the enhanced initial image frame.

13. A method for decoding and enhancing a video image stream from an enhanced initial image frame and a bitstream containing at least sampled baseline image data and image enhancement data, comprising:
separating the bitstream into blocks of sampled baseline image data and image enhancement data;
upsampling the sampled baseline image data to produce a first image frame;
determining motion vector data from a portion of the image enhancement data;
resampling the enhanced initial image frame based on the motion vector data to thereby obtain a resampled enhanced initial image frame;
blending the resampled enhanced initial image frame with the first image frame to produce a predicted image;
enhancing the predicted image by applying correction data to individual pixels, control for the correction data comprising a set of weighted texture maps identified on a block-by-block or pixel-by-pixel basis by a portion of the image enhancement data, to thereby obtain an enhanced first image frame; and
outputting the enhanced first image frame for display.

14. The method of claim 13, further comprising the steps of:
selecting an upsample filter; and
upsampling the enhanced first image frame using the upsample filter prior to outputting the enhanced first image frame for display.

15. The method of claim 13, wherein the weighted texture maps apply a weighted texture to selected 8 pixel by 8 pixel blocks comprising the predicted image.

16. The method of claim 13, wherein at least one of the weighted texture maps is provided as a portion of the image enhancement data.

17. The method of claim 13, wherein the step of applying correction data comprises applying correction data to individual pixels, and further comprises the steps of:
determining, by decoding a portion of the image enhancement data, a numerical multiplier;
determining an enhancement basis vector representing a texture map associated with the individual pixels; and
multiplying the enhancement basis vector by the multiplier to thereby obtain a decoded residual image.

18. The method of claim 17, wherein the step of applying correction data further comprises:
adding the decoded residual image to the predicted image in order to obtain an enhanced image.

19. A method for decoding and enhancing a video image stream from an enhanced initial image frame and a bitstream containing at least sampled baseline image data and image enhancement data, comprising:
separating the bitstream into blocks of sampled baseline image data and image enhancement data;
adaptively upsampling the sampled baseline image data on a block-by-block basis to produce a first image frame, the adaptive upsampling controlled at least in part by a portion of the image enhancement data for each block;
determining motion vector data based on said first image frame;
determining from the motion vector data mismatch image data;
resampling the enhanced initial image frame based on the motion vector data to thereby obtain a resampled enhanced initial image frame;
blending the resampled enhanced initial image frame with the first image frame, the blending control provided at least in part by the mismatch image data, to produce a predicted image;
enhancing the predicted image by applying correction data to individual pixels, control for the correction data comprising a set of weighted texture maps identified on a block-by-block or pixel-by-pixel basis by a portion of the image enhancement data, to thereby obtain an enhanced first image frame; and
outputting the enhanced first image frame for display.

20. The method of claim 19, further comprising the steps of:
selecting an upsample filter; and
upsampling the enhanced first image frame using the upsample filter prior to outputting the enhanced first image frame for display.

21. The method of claim 20, wherein the step of selecting the upsample filter comprising the steps of:
determining from the image enhancement data an upsampling classification specification for that block;
producing, using the determined upsampling classification specification an upsample class for that block;
determining from the image enhancement data and the upsample class an upsampling filter specification for that block; and
producing, using the determined upsampling filter specification and the upsample class an upsample filter for that block; and
wherein the step of upsampling the enhanced first image frame further comprises utilizing the upsample filter to obtain the enhanced output data.

22. The method of claim 19, wherein at least one of the weighted texture maps is provided as a portion of the image enhancement data.

23. The method of claim 19, wherein the step of applying correction data to individual pixels further comprises the steps of:
determining, by decoding a portion of the image enhancement data, a numerical multiplier;
determining an enhancement basis vector representing a texture map associated with the individual pixels;
multiplying the enhancement basis vector by the multiplier to thereby obtain a decoded residual image; and
adding the decoded residual image to the predicted image in order to obtain an enhanced image.
